(19) United States
(12) Patent Application Publication
(10) Pub. No.: US 2026/0104582 A1
(43) Pub. Date: Apr. 16, 2026

(54) FLEXIBLE SHAFTS FOR ENDOSCOPES

(71) Applicant: Auris Health, Inc., Santa Clara, CA (US)

(72) Inventors: Justin GILBERT, San Francisco, CA (US); Taylor FURTADO, Santa Clara, CA (US)

(73) Assignee: Auris Health, Inc., Santa Clara, CA (US)

(21) Appl. No.: 19/323,140

(22) Filed: Sep. 9, 2025

Related U.S. Application Data
(60) Provisional application No. 63/707,695, filed on Oct. 15, 2024.

(51) Int. Cl. G02B 23/24

(52) U.S. Cl. CPC G02B 23/2476

(57) ABSTRACT

An endoscope includes an elongate shaft having opposing first and second ends and including a distal jacket extending proximally from the first end, and a flexure shaft extending within the distal jacket. The endoscope further includes a distal tip arranged at the first end of the shaft, a control ring that operatively couples the distal tip to the flexure shaft, and a distal sealing extrusion secured to the shaft and sealing an interface between the control ring and at least one of the distal tip and the flexure shaft.

### BACKGROUND

Medical and surgical catheters, and more specialized versions of such catheters, such as bronchoscopes, are medical devices that are commonly used for purposes of medical diagnosis and treatment. Such “snake like” devices are designed to traverse various body lumens, such as arteries, veins, portions of the urinary, gastrointestinal, and reproductive systems, as well as various portions of the respiratory system and lungs. These devices are frequently used for other surgical applications as well.

Some of these medical devices are formed from long continuous tubes, often formed from medical grade polymers. Other such devices may comprise articulated sections formed from a plurality of smaller components that are linked together by flexible joints. Such articulated devices themselves may often then be covered with a flexible medical plastic grade polymer as well.

Some of these medical devices are intended for direct manipulation by the surgeon or other healthcare professional. Other such devices may have various motorized, processor-controlled, and even robotically-driven accessories. These are often used for greater precision and control.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 shows an example medical system that may incorporate one or more principles of the present disclosure.

FIG. 2 is a schematic diagram of the medical system of FIG. 1, according to some implementations.

FIG. 3 is an enlarged isometric view of an example of the endoscope of FIG. 1, according to one or more embodiments of the present disclosure.

FIG. 4 is an enlarged isometric view of the distal end of the endoscope of FIG. 3, according to one or more embodiments.

FIG. 5 is an enlarged isometric view of the shaft at the interface between the proximal hypotube and the flexure shaft, according to one or more embodiments.

FIG. 6 is an enlarged isometric view of the shaft at the interface between the flexure shaft and the distal tip, according to one or more embodiments.

FIG. 7 is an enlarged isometric view of an end of the distal jacket of FIG. 3, according to one or more embodiment of the present disclosure.

### DETAILED DESCRIPTION

Some medical procedures can now be performed, at least in part, by a robotic system or apparatus, which can aid a physician or technician in navigating or positioning such medical instruments. For example, during robotically assisted bronchoscopy, a physician controls a robotic system to advance and navigate a medical instrument (such as a bronchoscope) down the patient’s trachea and lungs using precise articulation commands from the robotic system until reaching a target location (such as the location of a lesion or lung nodule). The instrument can be tracked inside the anatomy using various imaging and/or sensor modalities. In some applications, once the distal end of the medical instrument is placed as desired, a needle can be precisely deployed to the target site, via endoluminal or percutaneous access, by leveraging the same imaging and/or sensor modalities.

Aspects of the present disclosure may be used to perform robotic-assisted medical procedures, such as endoscopic access, percutaneous access, or treatment for a target anatomical site. For example, robotic tools may engage or control one or more medical instruments to access a target site within a patient’s anatomy and/or perform a treatment at the target site. In some implementations, the robotic tools may be guided or controlled by a user (such as a physician or a technician). In other implementations, the robotic tools may operate in an autonomous or semi-autonomous manner.

Although systems and techniques are described herein in the context of robotic-assisted medical procedures, the systems and techniques may be applicable to other types of medical procedures that utilize camera and/or sensor data, such as procedures that do not rely on robotic tools or only utilize robotic tools in a very limited capacity. For example, the systems and techniques described herein may be applicable to medical procedures that rely on manually operated medical instruments. The systems and techniques described herein also may be applicable beyond the context of medical procedures, such as in simulated environments or laboratory settings, such as with models or simulators, among other examples.

Although certain aspects of the present disclosure are described in detail herein in the context of bronchoscopy and medical devices used in conjunction with bronchoscopy procedures, such context is provided for convenience and clarity, and the concepts disclosed herein are applicable to any suitable medical procedure including, but not limited to, renal, urological, or nephrological procedures, such as kidney stone removal and treatment procedures.

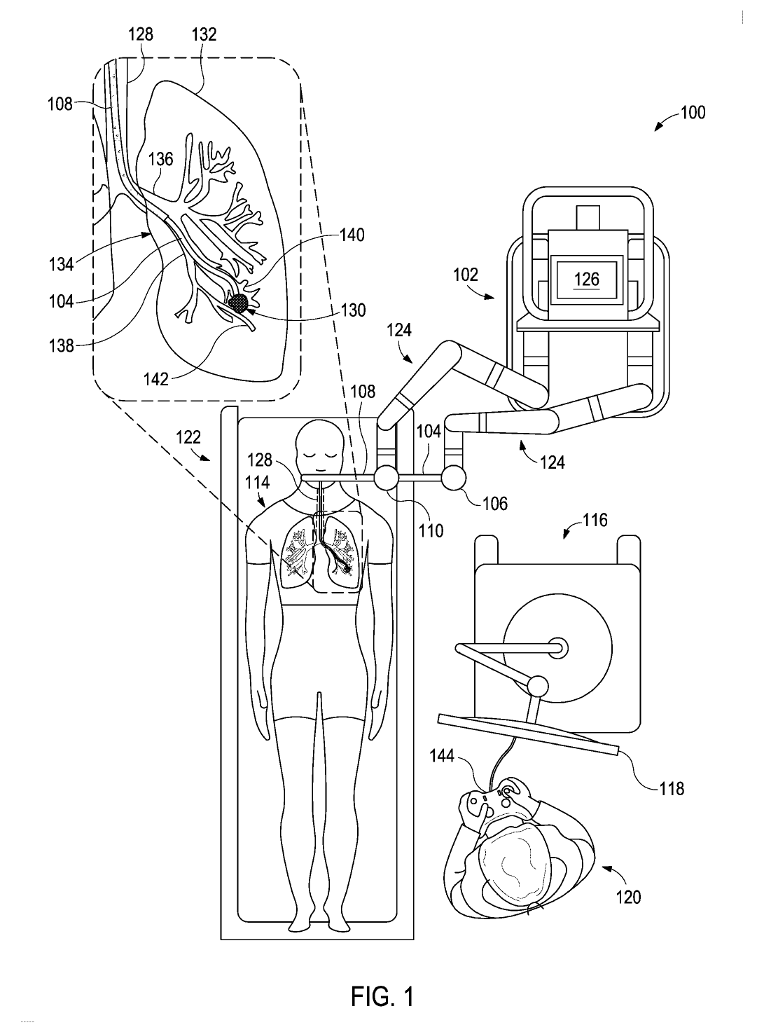

FIG. 1 shows an example medical system 100, according to some implementations. The medical system 100 may be used for, for example, endoscopic procedures. Robotic medical solutions can provide relatively higher precision, superior control, and/or superior hand-eye coordination with respect to certain instruments compared to strictly manual procedures. For example, robotic-assisted endoscopic access to patient anatomy can advantageously enable an operator to articulate an endoscope, sheath, or other instrument, using robotically-controlled gears/drives coupled to a handle/base portion of the instrument.

The medical system 100 includes a robotic system 102 (e.g., mobile robotic cart) configured to engage with and/or control an endoscope 104 (e.g., a bronchoscope), including a proximal base or “drive housing” 106, and a sheath 108, including a distal base or “drive housing” 110. The endoscope 104 is shown configured to perform a direct-entry procedure on a patient 114. As used herein, the term “patient” may generally refer to humans, anatomical models, simulators, cadavers, and other living or non-living objects. The term “direct-entry” is used herein according to its broad and ordinary meaning and may refer to any entry of instrumentation through a natural or artificial opening in a patient’s body, such as the mouth.

The medical system 100 includes a control system 116 configured to interface with the robotic system 102, provide information regarding a procedure, and/or perform a variety of other operations. For example, the control system 116 can include one or more display(s) 118 configured to present certain information to assist a physician 120 and/or other technician(s) or individual(s). The medical system 100 can include a table 122 configured to hold the patient 114.

Articulation of one or both of the endoscope 104 and the sheath 108 may be controlled robotically, such as through operation of robotic manipulators associated with one or more robotic arms 124 (two shown), wherein such operation may be controlled by the control system 116 and/or robotic system 102. The term “robotic manipulator” is used herein according to its broad and ordinary meaning and may refer to any type or configuration of one or more robotic end effectors, actuators, gears, drives, rails, interfaces, or the like. Additionally, the robotic system 102 may be used to move and/or control another instrument (e.g., a needle) inserted into the endoscope 104. In the illustrated embodiment, the proximal and distal drive housings 106, 110 are each operatively coupled and otherwise mounted to a corresponding robotic manipulator provided at the distal end of the corresponding robotic arms 124. Actuation of the corresponding robotic manipulator may cause one or both of the endoscope 104 and the sheath 108 to operate, such as in articulation.

Although the robotic arms 124 are shown in certain positions and coupled to certain instruments, such configurations are shown for convenience and illustration purposes, and the robotic arms 124 may have different configurations and poses over time and/or at different points during a medical procedure. Furthermore, the robotic arms 124 may be coupled to different devices/instruments than what is shown in FIG. 1, and in some cases one or more of the arms 124 may not be utilized or coupled to a medical instrument.

For illustrative purposes, FIG. 1 shows the robotic system 102 arranged for diagnostic and/or therapeutic bronchoscopy. During a bronchoscopy procedure, the arm(s) 124 may be configured to drive one or both of the endoscope 104 and the sheath 108 through a natural orifice access point (e.g., the mouth of the patient 114) to deliver diagnostic and/or therapeutic tools. As shown, the robotic system 102 (e.g., cart) may be positioned proximate to the patient’s upper torso in order to provide access to the access point. The arrangement in FIG. 1 may also be utilized when performing an upper gastro-intestinal (GI) procedure with a gastroscope, a specialized endoscope for GI procedures. The robotic system 102 can include a display 126 for providing procedure-related information to the user.

The endoscope 104 may be directed down the patient’s trachea 128 and lungs after insertion using precise articulation commands from the robotic system 102 until reaching the target operative site. For example, the endoscope 104 may be directed to deliver a needle (such as a biopsy needle or a drug delivery needle) to a target, such as a lesion or nodule 130 within the lungs of the patient 114. The needle may be deployed down a working channel that runs the length of the endoscope 104 to obtain a tissue sample to be analyzed by a pathologist. Although direct entry of the endoscope 104 is shown, aspects of the present disclosure relate to other types of subject entry, such as percutaneous entry.

For reference, FIG. 1 shows details of certain respiratory anatomy in which the endoscope 104 or the sheath 108 may be advanced and/or articulated. Generally, the respiratory system comprises certain passages, vessels, organs, and muscles that aid the body in the exchange of gases between the air and blood, and between the blood and the cells of the body. The respiratory system includes the upper respiratory tract, which comprises the nose/nasal cavity, the pharynx (i.e., throat), and the larynx (i.e., voice box). The respiratory system further includes the lower respiratory tract, which is shown in detail and comprises the trachea 128, the lungs 132, and the various segments of the bronchial tree 134, including the alveoli and alveolar ducts, which comprise clusters of small air sacs that are responsible for gas exchange between the lungs and the pulmonary blood vessels. The bronchial tree 134 includes primary bronchi 136, which branch off into smaller secondary 138 and tertiary 140 bronchi, and terminate in even smaller tubes called bronchioles 142. Each bronchiole tube 142 is coupled to a cluster of alveoli.

In FIG. 1, the patient 114 is with the lung nodule 130 formed in the area of the lungs 132. Such lung nodules 130 can be benign or cancerous. Robotically-controlled instrumentation can be implemented to perform a diagnostic biopsy procedure from within the bronchial network to determine whether the lung nodule 130 is cancerous, or whether specific treatment or therapies are advisable.

Although aspects of the present disclosure are presented in the context of luminal networks including a bronchial network of airways (e.g., lumens, branches) of a patient’s lung, embodiments of the present disclosure can be implemented in other types of luminal networks, such as renal networks, cardiovascular networks (e.g., arteries and veins), gastrointestinal tracts, urinary tracts, etc., without departing from the scope of the present disclosure.

The endoscope 104 may be any type of shaft-based medical instrument, including a bronchoscope, a catheter (such as a steerable or non-steerable catheter), a ureteroscope, a nephroscope, a gastroscope, a laparoscope, or another type of medical instrument. In some applications, the endoscope 104 may include one or more working channels through which additional tools/medical instruments, such as lithotripters, basketing devices, forceps, laser devices, imaging devices, etc., can be introduced into a treatment site.

In the illustrated example, the sheath 108 comprises an elongate tubular structure that defines a central channel or “lumen,” and the endoscope 104 is arranged within the central lumen of the sheath 108. The terms “lumen” and “channel” are used herein according to their broad and ordinary meanings and may refer to a physical structure forming a cavity, void, conduit, or other pathway, such as an at least partially rigid elongate tubular structure, or may refer to a cavity, void, pathway, or other channel, itself, that occupies a space within an elongate structure (e.g., a tubular structure). The telescopic arrangement of the endoscope 104 and the sheath 108 may allow for a relatively thin design of the endoscope 104 and may improve a bend radius of the endoscope 104 while providing a structural support via the sheath 108. Moreover, movement of the proximal drive housing 106 while maintaining the distal drive housing stationary may correspondingly move the endoscope 104 relative to the sheath 108, thereby allowing a distal tip of the endoscope 104 to advance past a distal end of the sheath 108, for example.

The terms “scope” and “endoscope” are used herein according to their broad and ordinary meanings and can refer to any type of elongate medical instrument having image generating, viewing, and/or capturing functionality and configured to be introduced into any type of organ, cavity, lumen, chamber, and/or space of a body. For example, references herein to scopes or endoscopes can refer to a ureteroscope (such as for accessing the urinary tract), a laparoscope, a nephroscope (such as for accessing the kidneys), a bronchoscope (such as for accessing an airway, such as the bronchus), a colonoscope (such as for accessing the colon), an arthroscope (such as for accessing a joint), a cystoscope (such as for accessing the bladder), or a borescope, among other examples.

A scope can comprise a tubular and/or flexible medical instrument that is configured to be inserted into the anatomy of a patient to capture images of the anatomy. In some implementations, a scope may accommodate wires and/or optical fibers to transfer signals to or from an optical assembly and a distal end of the scope, which can include an imaging device, such as an optical camera. The camera or imaging device can be used to capture images of an internal anatomical space. A scope can further accommodate optical fibers to carry light from proximately-located light sources, such as light-emitting diodes, to the distal end of the scope. The distal end of the scope can include ports for light sources to illuminate an anatomical space when using the camera or imaging device. In some implementations, the scope may be controlled by a robotic system, such as the robotic system 102. The imaging device can comprise an optical fiber, fiber array, and/or lens. The optical components can move along with the distal tip of the scope, such that movement of the distal tip results in changes to the images captured by the imaging device.

A scope can be articulable with respect to at least a distal portion of the scope to enable the scope to be steered within the human anatomy. In some implementations, a scope may be articulated with, for example, five or six degrees of freedom, including X, Y, Z coordinate movement, as well as pitch, yaw, and roll. A position sensor(s) of the scope can likewise have similar degrees of freedom with respect to the position information they produce or provide. A scope can include telescoping parts, such as an inner leader portion and an outer sheath portion, which can be manipulated to telescopically extend the scope. In some aspects, a scope may comprise a rigid or flexible tube configured to be passed within an outer sheath, catheter, introducer, or other lumen-type device, or can be used without such devices. In some implementations, a scope may include a working channel for deploying medical instruments (such as lithotripters, basketing devices, or forceps), irrigation, and/or aspiration to an operative region at a distal end of the scope.

In the control system 116, the display 118 may be a graphical user interface to display information, and may also be used to input instructions into the control system 116, such as by using a keyboard coupled to the display 118. The control system 116 may further include a controller 144, shown as a hand held controller, which may be used to control the medical system 100, such as controlling the robotic system 102 to manipulate and operate the endoscope 104 and/or the sheath 108. In some applications, the controller 144 may be configured to provide haptic feedback to the physician.

The terms “distal” and “proximal” as used herein refers to a location being either closer to or away from the working end of the end effector or instrument; the term “distal” being located at or near the working end of the end effector, and the term “proximal” being located away from the working end of the end effector and otherwise closer to the surgeon.

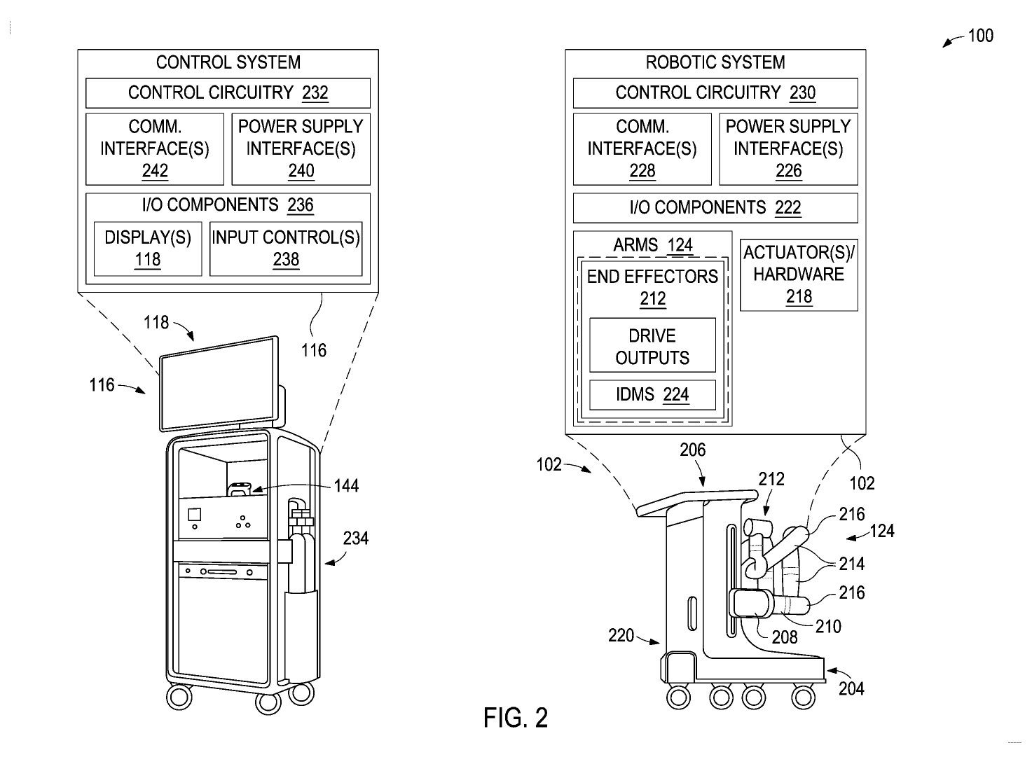

FIG. 2 is a schematic diagram of the medical system 100, according to some implementations. As illustrated, the robotic system 102 includes an elongated support structure or “column” 202 (also referred to as a “column”), a robotic system base 204, and a console 206 (e.g., display) at the top of the column 202. The column 202 may include one or more carriages or “arm supports” 208 for supporting the deployment of the robotic arms 124. The arm support 208 may include individually-configurable arm mounts that rotate along a perpendicular axis to adjust the base of the robotic arms 124 for better positioning relative to the patient. The robotic arms 124 are configured to engage with and/or control the endoscope 104 (FIG. 1) to perform aspects of a medical procedure. For example, a scope-advancement instrument coupling (such as an instrument device manipulator) can be attached to the distal portion of one of the arms 124, to facilitate robotic control or advancement of the endoscope 104, while another arm 124 may have associated therewith an instrument coupling configured to facilitate advancement of a needle through the endoscope 104.

The arm support 208 also includes a column interface that allows the arm support 208 to vertically translate along the column 202. In some implementations, the column interface can be connected to the column 202 through slots on opposite sides of the column 202 to guide the vertical translation of the arm support 208. Vertical translation of the arm support 208 allows the robotic system 102 to adjust the reach of the robotic arms 124 to meet a variety of table heights, patient sizes, and physician preferences.

The robotic arms 124 include robotic arm bases 210 and end effectors 212, separated by a series of linkages 214 that are connected by a series of joints 216, each joint 216 comprising one or more independent actuators 218. Each actuator 218 may comprise an independently-controllable motor, and each independently-controllable joint 216 can provide an independent degree of freedom of movement to the robotic arm 124. In some implementations, each arm 124 has seven joints, and thus provides seven degrees of freedom, including “redundant” degrees of freedom. Redundant degrees of freedom allow the robotic arms 124 to position their respective end effectors 212 at a specific position, orientation, and trajectory in space using different linkage positions and joint angles. This allows for the system to position and direct a medical instrument from a desired point in space while allowing the physician to move the arm joints into a clinically advantageous position away from the patient to create greater access, while avoiding arm collisions.

The robotic system base 204 can include wheels or “casters” 220 that allow for the robotic system 102 to easily move around the operating room prior to a procedure. After reaching the appropriate position, the casters 220 may be immobilized using wheel locks to hold the robotic system 102 in place during the procedure.

The console 206 is positioned at the upper end of the column 202 and provides one or more I/O components 222, such as a user interface for receiving user input and a display screen (or a dual-purpose device such as, for example, a touchscreen) to provide the physician or user with preoperative and intra-operative data. Example pre-operative data may include pre-operative plans, navigation and mapping data derived from pre-operative computed tomography (CT) scans, and/or notes from pre-operative patient interviews. Example intra-operative data may include optical information provided from the tool, sensor and coordinate information from sensors, as well as vital patient statistics, such as respiration, heart rate, and/or pulse. The console 206 may be positioned and tilted to allow a physician to view the console 206, the robotic arms 124, and the patient 114 (FIG. 1) while operating the console 206 from behind the robotic system 102.

The end effector 212 of each robotic arm 124 may comprise an instrument device manipulator (IDM) 224, which may be attached using a mechanism changer interface (MCI). In some implementations, the IDM 224 can be removed and replaced with a different type of IDM, for example, a first type of IDM may manipulate a scope, while a second type of IDM may manipulate a needle. Another type of IDM may be configured to hold an electromagnetic (EM) field generator. An MCI can include connectors to transfer pneumatic pressure, electrical power, electrical signals, and/or optical signals from the robotic arm 124 to the IDM 224. The IDMs 224 may be configured to manipulate medical instruments, such as the endoscope 104, using techniques including, for example, direct drives, harmonic drives, geared drives, belts and pulleys, magnetic drives, and the like. In some implementations, the IDMs 224 can be attached to respective robotic arms 124, wherein the robotic arms 124 are configured to insert or retract the respective coupled medical instruments into or out of the treatment site.

The robotic system 102 further includes power 226 and communication interfaces 228 (such as connectors) to transfer pneumatic pressure, electrical power, electrical signals, and/or optical signals from the robotic arms 124 to the IDMs 224.

The medical further can include control circuitry configured to perform certain functionality described herein, including control circuitry 230 of the robotic system 102 and/or control circuitry 232 of the control system 116. That is, the control circuitry of the medical system 100 may be part of the robotic system 102, the control system 116, or some combination thereof. Therefore, any reference herein to control circuitry may refer to circuitry embodied in a robotic system, a control system, or any other component of a medical system, such as the medical system 100 shown in FIG. 1 or the medical system 100.

The control circuitry 230, 232 may comprise a computer-readable medium storing (or configured to store) hard-coded and/or operational instructions corresponding to at least some of the steps and/or functions illustrated in one or more of the implementations described herein. The control circuitry 230, 232 may be locally maintained on the robotic system 102 or the control system 116 or may be remotely located at least in part (such as communicatively coupled indirectly via a local area network and/or a wide area network). Any of the control circuitry 230, 232 may be configured to perform any aspect(s) of the various processes disclosed herein.

With respect to the robotic system 102, at least a portion of the control circuitry 230 may be integrated with the base 204, column 202, and/or console 206 of the robotic system 102, and/or another system communicatively coupled to the robotic system 102. With respect to the control system 116, at least a portion of the control circuitry 232 may be integrated with a console base 234 and/or the display 118 of the control system 116.

Still referring to FIG. 2, the control system 116 includes various I/O components 236 configured to assist the physician 120 (FIG. 1) or others in performing a medical procedure. The I/O components 236 can be configured to allow for user input to control or navigate the endoscope 104 (FIG. 1) and/or a needle within the patient 114 (FIG. 1). In some implementations, the physician 120 can provide input to the control system 116 and/or robotic system 102 via one or more input controls 238, wherein in response to such input, control signals can be sent to the robotic system 102 to manipulate the endoscope 104 and/or a needle. Example input controls 238 include any type of user input devices or device interfaces, such as buttons, keys, joysticks, handheld controllers (such as video-game type controllers), computer mice, trackpads, trackballs, control pads, foot pedals, sensors (such as motion sensors or cameras) that capture hand or finger gestures, or touchscreens, among other examples. In some applications, the input controls 238 include the controller 144.

The control system 116 includes one or more power supplies or supply interfaces 240, pneumatic devices, optical sources, actuators, data storage devices, and/or communication interfaces 242.

The various components of the medical system 100 can be communicatively coupled to each other over a network, which can include a wireless and/or wired network. Example networks include one or more personal area networks (PANs), local area networks (LANs), wide area networks (WANs), Internet area networks (IANs), cellular networks, the Internet, personal area networks (PANs), body area network (BANs), etc. For example, the communication interfaces 228, 254 of the robotic system 102 and the control system 116, respectively, can be configured to communicate with one or more devices, sensors, or systems, such as over a wireless and/or wired network connection. In some implementations, the various communication interfaces can implement a wireless technology such as Bluetooth, Wi-Fi, near field communication (NFC), or the like. Furthermore, in some implementations, the various components of the system 100 can be connected for data communication, fluid exchange, power exchange, and so on via one or more support cables, tubes, or the like.

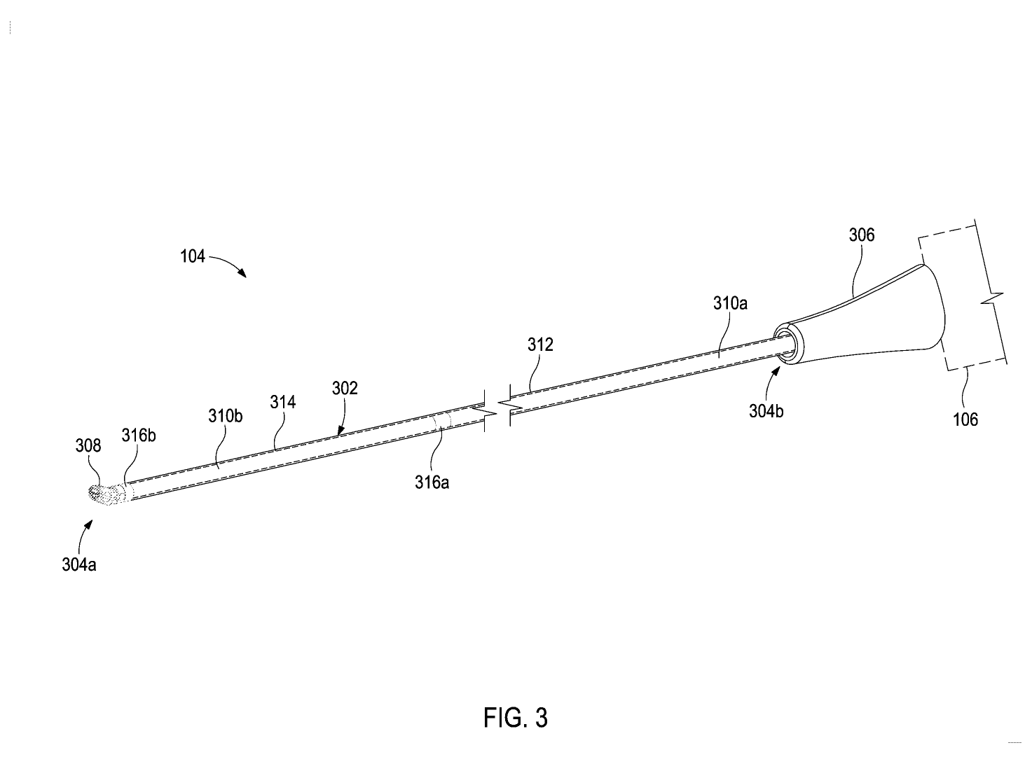

FIG. 3 is an enlarged isometric view of an example of the endoscope 104, according to one or more embodiments of the present disclosure. As illustrated, the endoscope generally comprises an elongate shaft 302 having a first or “distal” end 304a and a second or “proximal” end 304b opposite the distal end 304a. An adapter 306 may be provided at the proximal end 304b and may be configured to operatively couple the shaft 302 to the proximal drive housing 106 (shown in dashed lines). A distal tip 308 is provided at the distal end 304a and may include, among other items, an imaging device, one or more light sources, and sensors for navigation and positioning of scope based on preoperative scans.

The shaft 302 may be made up of several component parts. In particular, as illustrated, the shaft 302 includes a proximal sheath or “jacket” 310a and a distal sheath or “jacket” 310b. One or both of the jackets 310a,b may be made of a flexible medical grade polymer. In at least one application, however, only the distal jacket 310b may be flexible, whereas the proximal jacket 310a may be made of a material that is more rigid than the distal jacket 310b. The proximal jacket 310a may extend over and otherwise cover a proximal hypotube 312 (shown as dashed lines), and the distal jacket 310b extends over and covers a flexible or “flexure” shaft 314 (shown as dashed lines).

As described in more detail below, the shaft 302 may include a mid-hub coupler (not visible), which may help operatively couple the proximal hypotube 312 to the flexure shaft 314, and a control ring (not visible), which may help operatively couple the flexure shaft 314 to the distal tip 308. A mid-sealing extrusion 316a may be provided at the interface between the proximal hypotube 312 and the flexure shaft 314, and a distal sealing extrusion 316b may be provided at the interface between the flexure shaft 314 and the control ring. The mid-sealing extrusion 316a may be configured to seal the interface between the proximal hypotube 312 and the flexure shaft 314, and the distal sealing extrusion 316b may be configured to seal the interface between the flexure shaft 314 and the control ring. Accordingly, one or both of the extrusions 316a,b may be configured to help prevent the influx of fluids and/or debris during operation of the endoscope 104.

The mid-sealing extrusion 316a and the distal sealing extrusion 316b may each be made of a medical grade polymer, for example. In some embodiments, one or both of the extrusions 316a,b may be made of a heat shrinkable plastic film. In such embodiments, applying heat to the material causes the extrusion 316a,b to tightly enclose about the underlying structures; e.g., the mid-hub coupler and the control ring. Moreover, in such embodiments, applying (installing) the extrusion 316a,b may also extend to overlap portions of the proximal and distal jackets 310a,b. In other embodiments, however, one or both of the extrusions 316a,b may be made of a flowable plastic. In such embodiments, the material for the extrusions 316a,b may be heated and flowed over the underlying structures, and thereby provide a fluid tight seal.

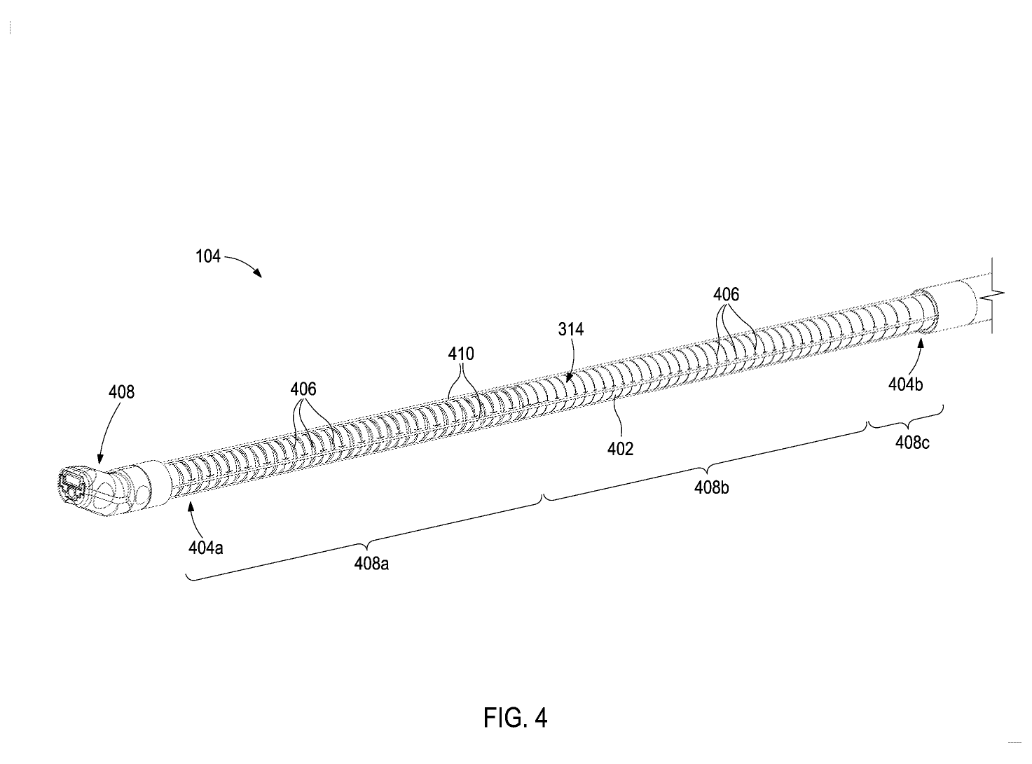

FIG. 4 is an enlarged isometric view of the distal end of the endoscope 104, according to one or more embodiments. In the illustrated view, the distal jacket 310b is omitted, thereby exposing the flexure shaft 314. As illustrated, the flexure shaft 314 includes an elongate body 402 having opposing first (distal) and second (proximal) ends 404a and 404b. The distal end 404a is operatively coupled to the control ring (not visible), and the proximal end 404b is operatively coupled to the mid-hub coupler (not visible).

The flexure shaft 314 comprises a laser cut shaft that includes a plurality of cuts 406 made by a laser for the purpose of increasing the flexibility of the body 402. In the illustrated embodiment, the laser cuts 406 are provided in a generally “dog bone” design, but could alternatively be formed and otherwise defined with other geometry, patterns, or designs, without departing from the scope of the disclosure. In other embodiments, for example, the laser cuts 406 could be provided in a ball and socket design, in alternating and overlapping cuts in the axial direction, defined helically (spiraled) yet parallel to each other, or in a variety of other designs.

In some embodiments, the size or frequency of the laser cuts 406 may be constant along the entire length of the body 402. In other embodiments, however, the size or frequency of the laser cuts 406 may vary along the length of the body 402. More specifically, as illustrated, the body 402 may include two or more flex zones, shown as a first flex zone 408a, a second flex zone 408b, and a third flex zone 408c. The flex zones 408a-c may each exhibit an axial length that may or may not be the same as any of the other flex zones 408a-c. In the illustrated embodiment, for example, the first and second flex zones 408a,b exhibit generally the same length, but the third flex zone 408c exhibits a length much smaller than the first and second flex zones 408a,b. Moreover, the size and frequency of the laser cuts 406 in the first flex zone 408a is different than the size and/or frequency of the laser cuts 406 in one or both of the second and third flex zones 408b,c.

One or more cables or “pull wires” 410 extend along the length of the shaft 302 (FIG. 3) and, more particularly along the length of the flexure shaft 314. In contrast to conventional flexure shaft designs, where pull wires are typically threaded to or extend within the interior of the flexure shaft, the pull wires 410 are arranged on the exterior of the body 402 of the flexure shaft 314. The pull wires 410 extend proximally from the distal tip 308 to one or more manipulation components in the drive housing 106 (FIGS. 1 and 3) where the pull wires 410 can be manipulated to control movement of the distal tip 308 and articulation of the flexure shaft 314.

The pull wires 410 can comprise wires, cables, fibers, and/or flexible shafts and can be made of any suitable or desirable material such as, but not limited to, metallic and non-metallic materials, including stainless steel, Kevlar, tungsten, carbon fiber, and the like. In the illustrated embodiment, four pull wires 410 are included (only two visible), but any number of pull wires 410 can be implemented, without departing from the scope of the disclosure.

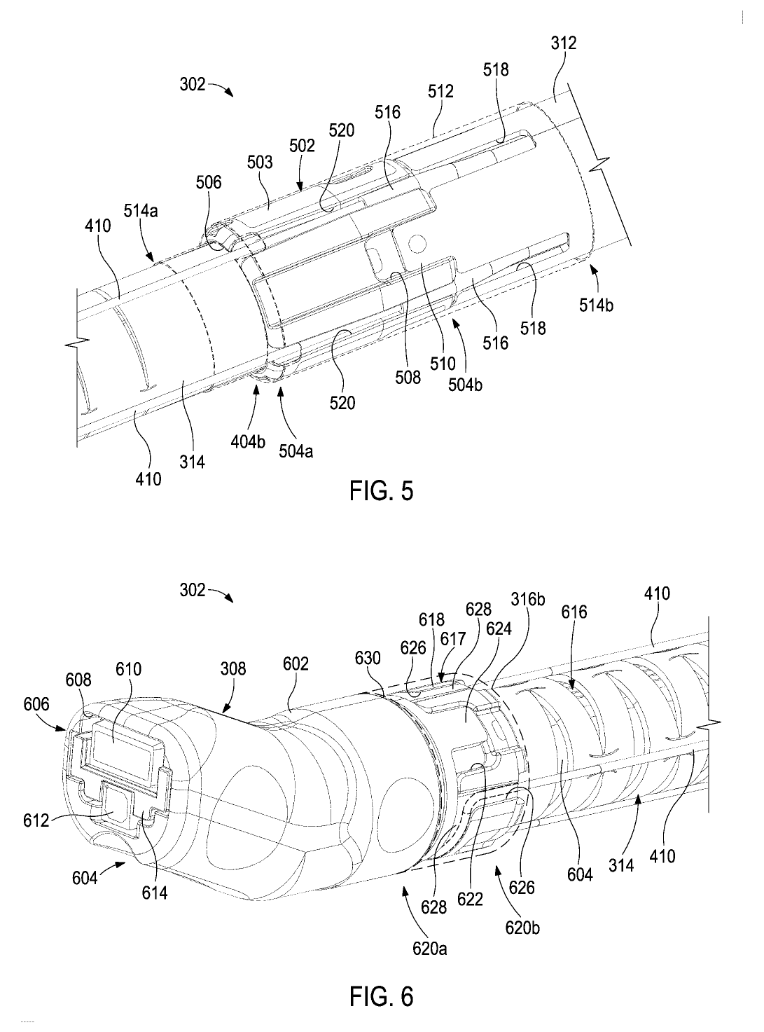

FIG. 5 is an enlarged isometric view of the shaft 302 at the interface between the proximal hypotube 312 and the flexure shaft 314, according to one or more embodiments. As illustrated, the shaft 302 includes a mid-hub coupler 502, which, as briefly mentioned above, helps to operatively couple the proximal hypotube 312 to the flexure shaft 314. The mid-hub coupler 502 constitutes a transition between the passive region of the shaft 302, where no shaft articulation occurs, and the active region of the shaft 302, where shaft articulation is possible by operation of the pull wires 410.

As illustrated, the mid-hub coupler 502 includes a generally cylindrical body 503 having opposing first and second ends 504a and 504b. The body 503 may define an interior 506 that extends between the opposing ends 504a,b. In some embodiments, as illustrated, the first end 504a of the mid-hub coupler 502 may be sized and otherwise configured to receive the proximal end 404b of the flexure shaft 314. More specifically, the opening to the interior 506 at the first end 504a may be sized to receive the proximal end 404b of the flexure shaft 314.

At the proximal end 504b, the body 503 may provide and otherwise define one or more interlocking features 508 configured to mate with one or more corresponding interlocking features 510 provided by the proximal hypotube 312. In the illustrated embodiment, for example, the interlocking feature 508 comprises a depression or recess defined in the body 503, and the corresponding interlocking feature 510 comprises an extension or tab provided by the proximal hypotube 312. Mating the interlocking features 508, 510 may help prevent relative rotation between the proximal hypotube 312 and the mid-hub coupler 502. While one example of the interlocking features 508, 510 is shown in FIG. 5, it will be appreciated that the interlocking features 508, 510 may assume any geometric shape or configuration, without departing from the scope of the disclosure.

In some embodiments, the shaft 302 may further include a lamination barrier 512 (shown in dashed lines) may be applied to the shaft 302 at the location of the mid-hub coupler 502. As illustrated, the lamination barrier 512 can exhibit a length that extends across the interface of the mid-hub coupler 502 with both the proximal hypotube 312 and the flexure shaft 314. More specifically, when the lamination barrier 512 is properly assembled on the shaft 302, a distal end 514a of the lamination barrier 512 may extend distally past the first end 504a of the mid-hub coupler 502, and a proximal end 514b of the lamination barrier 512 may extend proximally past the second end 504b of the mid-hub coupler 502.

The lamination barrier 512 may be made of a medical grade polymer. In some embodiments, for example, the lamination barrier 512 may be made of a heat shrinkable plastic film. In such embodiments, applying heat to the material causes the lamination barrier 512 to tightly enclose about the underlying structures of the mid-hub coupler 502 and adjacent portions of the proximal hypotube 312 and the flexure shaft 314. In some embodiments, the lamination barrier 512 exhibits a higher melting or transition temperature as compared to the material of the mid-sealing extrusion 316a, which may help in preventing polymer material from entering the inner diameter of the scope. Once the first end 504a of the mid-hub coupler 502 is operatively coupled to the proximal end 404b of the flexure shaft 314, and once the interlocking features 508 of the mid-hub coupler 502 are properly mated with the corresponding interlocking features 510 of the proximal hypotube 312, the lamination barrier 512 may be heated and fit across the interfaces between the mid-hub coupler 502 and both the proximal hypotube 312 and the flexure shaft 314. The lamination barrier 512 may be configured to help prevent the influx of fluids and/or debris during operation of the endoscope 104, and thereby may be configured to provide a fluid tight seal.

The mid-hub coupler 502 may also be configured to transition the pull wires 410 from the interior of the proximal hypotube 312 to the exterior of the flexure tube 314. More specifically, as illustrated, the shaft 302 may include a plurality of force isolation tubes 516 (two shown) configured to help guide corresponding pull wires 410 from the interior of the proximal hypotube 312, across the mid-hub coupler 512, and to the exterior of the flexure tube 314. The force isolation tubes 516, alternately referred to as “Bowden” tubes, are made of any suitable material, such as a metal (e.g., stainless steel) or a polymer.

The force isolation tubes 516 are sized and otherwise configured to be received within corresponding features of both the proximal hypotube 312 and the mid-hub coupler 502. More specifically, the proximal end of each force isolation tube 516 may be configured to be received within a corresponding elongate slot 518 provided by the proximal hypotube 312, and the distal end of each force isolation tubes 516 may be configured to be received within a corresponding channel 520 provided by the mid-hub coupler 502. Each channel 520 may extend between the first and second ends 504a,b of the mid-hub coupler 502. Angularly aligning and mating the interlocking features 508 of the mid-hub coupler 502 with the corresponding interlocking features 510 of the proximal hypotube 312, will correspondingly angularly align each elongate slot 518 with a corresponding channel 520, thereby being able to accommodate an individual force isolation tube 516.

In at least one embodiment, one or more of the force isolation tubes 516 may be laser welded at the interface between the mid-hub coupler 502 and the proximal hypotube 312, thereby securing the force isolation tubes 516 axially and rotationally in place. In other embodiments, or in addition thereto, poke-yoke and self-locating geometries of the force isolation tubes 516 and the corresponding slots 518 and channel 520 may help reduce assembly errors. The force isolation tubes 516 may prove advantageous in creating a fixed path length for the pull wires 410. Moreover, the force isolation tubes 516 operate to isolate forces transitioning from the pull wires to the flexure shaft 314. The force isolation tubes 516 exhibit minimal compression, or in the case of the presently described architecture, zero compression under load. This translates to less slack, slop, and/or backlash and more accurate commanded driving in robotically controlled scopes.

FIG. 6 is an enlarged isometric view of the shaft 302 at the interface between the flexure shaft 314 and the distal tip 308, according to one or more embodiments. The distal tip 308 forms the distal end of the endoscope 104 (FIGS. 1, 3, and 4) and is operatively coupled to the flexure shaft 314. The distal tip 308 provides a housing 602 that at least partially defines a working channel 604 that extends through or otherwise communicates with the interior of the flexure shaft 314. The working channel 604 is sized to allow deployment of a variety of tools therethrough, as generally described above.

The housing 602 may also be designed to accommodate and otherwise house an endoscope tip electronics assembly 606. The endoscope tip electronics assembly 606 (hereafter “the electronics assembly 606”) is sized and otherwise configured to be received within a cavity 608 defined within the housing 602. In particular, the housing 602 defines a distal opening that facilitates access to the cavity 608. The electronics assembly 606 includes a plurality of electrical components including, but not limited to, an imaging device 610 (e.g., a camera) and a light source 612. In some embodiments, as illustrated, the electronics assembly 606 may further include a carrier 614 configured to receive and secure the imaging device 610 and the light source 612 within the cavity 608 such that the imaging device 610 and the light source 612 are positioned at the distal opening, thus being exposed at the distal end of the distal tip 308 to enable image capture and transmission during operation of the endoscope 300. In other embodiments, however, the carrier 614 may be omitted, and the imaging device 610 and the light source 612 may instead be received within and otherwise mounted to corresponding pockets or apertures defined by the housing 602.

One or more wires 616 (visible through the laser cuts in the flexure shaft 314) extend to and terminate at the electronics assembly 606. The wires 616 may be configured to convey signals and power to and from the electrical components included in the electronics assembly 606, such as the imaging device 610 and the light source 612. In some embodiments, the electronics assembly 606 may further include one or more electromagnetic (EM) sensors (not shown) secured within the housing 602. In such embodiments, the wires 616 may include one or more electrical leads extending to and terminating at the EM sensors to provide electrical power and signals thereto.

As illustrated, the wires 616 are configured to extend within the interior of the flexure shaft 314 and terminate at the distal tip 308. In contrast to conventional flexure shafts, which may include a plurality of interconnected linkages or component parts, the laser cut flexure shaft 314 exhibits a larger inner diameter that is able to accommodate the wires 616. In one or more embodiments, the wires 616 include four wires configured to transmit power and signals to the electrical components of the electronics assembly 606, such as the imaging device 610 and the light source 612. Two additional electrical leads may be included to extend to the electromagnetic (EM) sensors. In at least one embodiment, these additional electrical leads can extend within corresponding tubes.

Because of the larger inner diameter of the laser cut flexure shaft 314, the wires 616 can be “ribbonized”. This means that the wires running to the electronics assembly 606 can be attached (e.g., welded) together, and the tubes that house the EM sensors can be attached (e.g., welded) to the other wires, thereby providing a common structure. Ribbonizing the wires 616 makes assembly of the wires 616 easier and less prone to electrical failure, which can improve the durability of the device.

As illustrated, the shaft 302 includes a control ring 617, which, as briefly mentioned above, helps to operatively couple the distal tip 308 to the flexure shaft 314. The control ring 617, alternately referred to as a “wire termination device,” includes a generally cylindrical body 618 having opposing first and second ends 620a and 620b, and defining an interior that extends between the opposing ends 620a,b. In some embodiments, as illustrated, the first end 620a of the control ring 617 may be sized and otherwise configured to receive the distal end 404a of the flexure shaft 314. More specifically, the opening to the interior of the body 618 at the second end 620b may be sized to receive the distal end 404a of the flexure shaft 314.

At the distal end 620a, the body 618 may provide and otherwise define one or more interlocking features 622 configured to mate with one or more corresponding interlocking features 624 provided by the distal tip 308. In the illustrated embodiment, for example, the interlocking feature 622 comprises a depression, slot, or recess defined in the body 618, and the corresponding interlocking feature 624 comprises an extension or tab provided by the distal tip 308. Mating the interlocking features 622, 624 helps prevent relative rotation between the control ring 617 and the distal tip 308. While one example of the interlocking features 622, 624 are shown in FIG. 6, it will be appreciated that the interlocking features 622, 624 may assume any geometric shape or configuration suitable for providing an operative coupling between the control ring 617 and the distal tip 308, without departing from the scope of the disclosure.

As illustrated, one or more wire grooves or channels 626 may be defined in the body 618 of the control ring 617 and sized to receive one or more of the pull wires 410. The wire channel 626 may generally define C or U-shaped routes or paths that include first and second axial legs extending substantially parallel to the flexure shaft 314, and a transverse portion that interconnects the axial legs. The transverse portion may extend circumferentially about a segment of the control ring 617 to interconnect the axial legs. Accordingly, a single pull wire 410 may extend through one of the wire channel 626, thereby resulting in two portions of the pull wire 410 extending parallel to each other in the proximal direction. Routing the pull wires 410 through the wire channels 626 allows the drive housing 106 (FIGS. 1 and 3) to selectively apply tension to create reaction forces that facilitate antagonistic movement of the pull wires 410 and thereby enable articulation of the flexure shaft 314 and the distal tip 308.

While the wire channel 626 is described herein as exhibiting a generally C or U-shaped route or path, it is contemplated herein to include other path geometries including, but not limited to S-shaped curved, curvilinear path, or a tortuous path, without departing from the scope of the disclosure.

In some embodiments, the pull wires 410 may be attached to the control ring 617 by applying or otherwise depositing a material 628 within the wire channel 626. In such embodiments, for example, the material 628 may comprise an epoxy or another flowable material that, when hardens, not only encapsulates the pull wires 410 but also rigidly secures the pull wires 410 to the control ring 617.

Once the pull wires 410 are properly received within the wire channel 626, the distal sealing extrusion 316b (shown in dashed lines) may be secured over the interface between the distal tip 308 and the control ring 617. The distal sealing extrusion 316b may be sized to fit over top and circumferentially cover the entire outer circumference of the control ring 617, including the wire channels 626. As illustrated, the distal sealing extrusion 316b extends over portions of both the distal tip 308 and the control ring 617. More specifically, the distal tip 308 may provide a proximal shoulder 630, and the distal sealing extrusion 316b may extend to and contact the proximal shoulder 630. Accordingly, the distal sealing extrusion 316b may also be configured to cover and otherwise encapsulate the mated engagement between the interlocking features 622, 624.

As noted above, the distal sealing extrusion 316b may be made of a medical grade polymer, such as a heat shrinkable plastic film. Applying heat to the material of the distal sealing extrusion 316b causes the material to tightly enclose about the control ring 617, portions of the distal tip 308, etc. in other embodiments, however, the distal sealing extrusion 316b may be made of other materials, such as plastics or metals, and may be secured to the control ring 617 and the distal tip 308 through use of an adhesive, laser welding, laminating, soldering, chemical bonding, etc. with the distal sealing extrusion 316 properly seated and installed, the material may provide a fluid tight seal, which prevents the inflection of fluids and/or debris into the interior of the shaft 302.

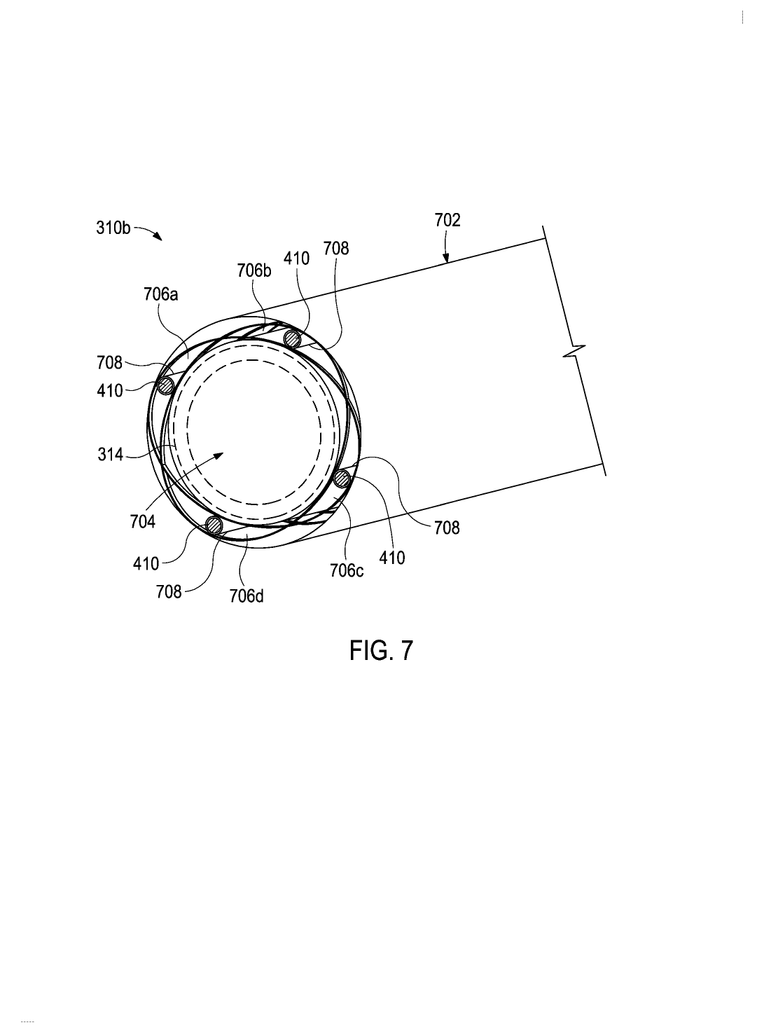

FIG. 7 is an enlarged isometric view of an end of the distal jacket 310b, according to one or more embodiment of the present disclosure. As illustrated, the distal jacket 310b includes an elongate body 702 that defines a central lumen 704 extending along the entire length of the body 702. The central lumen 704 may be sized and otherwise configured to receive the flexure shaft 314 (shown as dashed lines). Accordingly, the distal jacket 310b is configured to extend over and cover the flexure shaft 314. As noted above, the distal jacket 310b may be made of a compliant or flexible material, which allows free articulation of the flexure shaft 314 within the central lumen 704.

In the illustrated embodiment, the distal jacket 310b further provides or otherwise defines a plurality of minor lumens, shown as first, second, third, and fourth minor lumens 706a, 706b, 706c, and 706d. Accordingly, in at least one embodiment, the distal jacket 310b may be characterized as a five-lumen shaft. Each minor lumen 706a-d extends along the entire length of the body 702, and is sized to receive a corresponding one of the pull wires 410. The pull wires 410 are free to translate within the minor lumens 706a-d. In at least one embodiment, one or more of the pull wires 410 may extend within a corresponding hypotube 708 received within and extending along the associated minor lumen 706a-d. The hypotubes 708 may be made of a flexible and wear resistant material, such as nylon, thereby helping to mitigate damage or where to the pull wires 410 during articulation of the flexure shaft 314.

### Embodiments disclosed herein include:

A. An endoscope includes an elongate shaft having opposing first and second ends and including a distal jacket extending proximally from the first end, and a flexure shaft extending within the distal jacket. The endoscope further includes a distal tip arranged at the first end of the shaft, a control ring that operatively couples the distal tip to the flexure shaft, and a distal sealing extrusion secured to the shaft and sealing an interface between the control ring and at least one of the distal tip and the flexure shaft.

B. An endoscope includes an elongate shaft having opposing first and second ends and including a distal jacket extending proximally from the first end and defining a central lumen and one or more minor lumens, a flexure shaft extending within the central lumen, a proximal jacket extending distally from the second end, a proximal hypotube extending within the proximal jacket, and a mid-hub coupler interposing and operatively coupling the proximal hypotube to the flexure shaft. The endoscope further includes a distal tip arranged at the first end of the shaft, and one or more pull wires extending along the shaft between the first and second ends, the one or more pull wires extending within an interior of the proximal hypotube, and transitioning to an exterior of the flexure shaft at the mid-hub coupler, wherein the one or more pull wires extend within the one or more minor lumens along a length of the distal jacket.

Each of embodiments A and B may have one or more of the following additional elements in any combination: Element 1: wherein the shaft further includes a proximal jacket extending distally from the second end, a proximal hypotube extending within the proximal jacket, a mid-hub coupler interposing and operatively coupling the proximal hypotube to the flexure shaft, and a mid-sealing extrusion provided at an interface between the proximal hypotube and the flexure shaft and configured to seal the interface between the proximal hypotube and the flexure shaft. Element 2: further comprising one or more pull wires extending along a length of the shaft, the one or more pull wires extending within an interior of the proximal hypotube, and transitioning to an exterior of the flexure shaft at the mid-hub coupler, wherein the one or more pull wires extend along the exterior of the flexure shaft to the control ring. Element 3: further comprising one or more force isolation tubes extending between the proximal hypotube and the mid-hub coupler, the one or more force isolation tubes being configured to guide the one or more pull wires from the interior of the proximal hypotube and to corresponding channels defined by the mid-hub coupler. Element 4: wherein the mid-hub coupler provides a cylindrical body that defines an interior, and wherein an end of the flexure shaft is received within the interior. Element 5: wherein the mid-hub coupler provides one or more interlocking features configured to mate with one or more corresponding interlocking features provided by the proximal hypotube. Element 6: further comprising a lamination barrier mounted to the shaft and extending across an interface of the mid-hub coupler with both the proximal hypotube and the flexure shaft. Element 7: wherein the flexure shaft comprises a laser cut shaft including a plurality of cuts that increase flexibility of the flexure shaft. Element 8: wherein at least one of a size and a frequency of the plurality of cuts varies along a length of the flexure shaft. Element 9: wherein the plurality of cuts are segmented into a plurality of flex zones, and wherein at least one of a size and a frequency of the plurality of cuts is different in at least two flex zones of the plurality of flex zones. Element 10: further comprising one or more wires extending within an interior of the flexure shaft and terminating at an electronics assembly housed within the distal tip. Element 11: wherein the control ring provides a cylindrical body that defines an interior, and wherein an end of the flexure shaft is received within the interior. Element 12: wherein the distal tip provides one or more interlocking features configured to mate with one or more corresponding interlocking features provided by the control ring, and wherein the distal sealing extrusion covers an interface of mated engagement between the one or more interlocking features of the distal tip and the control ring. Element 13: wherein the distal tip provides a proximal shoulder, and wherein the distal sealing extrusion extend to and contacts the proximal shoulder. Element 14: wherein one or more wire channels are defined in the control ring and the one or more pull wires are received within the one or more wire channels, and wherein the distal sealing extrusion covers the one or more wires received within the one or more wire channels. Element 15: wherein the distal sealing extrusion is made of a medical grade polymer and is heat shrinkable. Element 16: wherein the distal sealing extrusion is made of a medical grade polymer and is a flowable plastic.

Element 17: further comprising a control ring that operatively couples the distal tip to the flexure shaft, a distal sealing extrusion secured to the shaft and sealing an interface between the control ring and at least one of the distal tip and the flexure shaft, and a mid-sealing extrusion provided at an interface between the proximal hypotube and the flexure shaft and configured to seal the interface between the proximal hypotube and the flexure shaft. Element 18: wherein one or both of the distal and mid-sealing extrusions is made of a medical grade polymer and is heat shrinkable.

By way of non-limiting example, exemplary combinations applicable to A, B, and C include: Element 1 with Element 2; Element 2 with Element 3; Element 1 with Element 4; Element 4 with Element 5; Element 1 with Element 6; Element 7 with Element 8; Element 7 with Element 9; and Element 12 with Element 13.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure.

The term “coupled” as used herein means connected directly to or connected through one or more intervening components or circuits. The terms “electronic system” and “electronic device” may be used interchangeably to refer to any system capable of electronically processing information. Moreover, certain standard anatomical terms of location may be used herein to refer to the anatomy of animals, and namely humans, with respect to the example implementations. Although certain spatially relative terms, such as “outer,” “inner,” “upper,” “lower,” “below,” “above,” “vertical,” “horizontal,” “top,” “bottom,” and similar terms, are used herein to describe a spatial relationship of one element, device, or anatomical structure to another device, element, or anatomical structure, it is understood that these terms are used herein for ease of description to describe the positional relationship between elements and structures, as illustrated in the drawings. It should be understood that spatially relative terms are intended to encompass different orientations of the elements or structures, in use or operation, in addition to the orientations depicted in the drawings. For example, an element or structure described as “above” another element or structure may represent a position that is below or beside such other element or structure with respect to alternate orientations of the subject patient, element, or structure, and vice-versa.

The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. An endoscope, comprising:
an elongate shaft having opposing first and second ends and including:
a distal jacket extending proximally from the first end; and
a flexure shaft extending within the distal jacket;
a distal tip arranged at the first end of the shaft;
a control ring that operatively couples the distal tip to the flexure shaft; and
a distal sealing extrusion secured to the shaft and sealing an interface between the control ring and at least one of the distal tip and the flexure shaft.

2. The endoscope of claim 1, wherein the shaft further includes:
a proximal jacket extending distally from the second end;
a proximal hypotube extending within the proximal jacket;
a mid-hub coupler interposing and operatively coupling the proximal hypotube to the flexure shaft; and
a mid-sealing extrusion provided at an interface between the proximal hypotube and the flexure shaft and configured to seal the interface between the proximal hypotube and the flexure shaft.

3. The endoscope of claim 2, further comprising one or more pull wires extending along a length of the shaft, the one or more pull wires extending within an interior of the proximal hypotube, and transitioning to an exterior of the flexure shaft at the mid-hub coupler, wherein the one or more pull wires extend along the exterior of the flexure shaft to the control ring.

4. The endoscope of claim 3, further comprising one or more force isolation tubes extending between the proximal hypotube and the mid-hub coupler, the one or more force isolation tubes being configured to guide the one or more pull wires from the interior of the proximal hypotube and to corresponding channels defined by the mid-hub coupler.

5. The endoscope of claim 2, wherein the mid-hub coupler provides a cylindrical body that defines an interior, and wherein an end of the flexure shaft is received within the interior.

6. The endoscope of claim 5, wherein the mid-hub coupler provides one or more interlocking features configured to mate with one or more corresponding interlocking features provided by the proximal hypotube.

7. The endoscope of claim 2, further comprising a lamination barrier mounted to the shaft and extending across an interface of the mid-hub coupler with both the proximal hypotube and the flexure shaft.

8. The endoscope of claim 1, wherein the flexure shaft comprises a laser cut shaft including a plurality of cuts that increase flexibility of the flexure shaft.

9. The endoscope of claim 8, wherein at least one of a size and a frequency of the plurality of cuts varies along a length of the flexure shaft.

10. The endoscope of claim 8, wherein the plurality of cuts are segmented into a plurality of flex zones, and wherein at least one of a size and a frequency of the plurality of cuts is different in at least two flex zones of the plurality of flex zones.

11. The endoscope of claim 1, further comprising one or more wires extending within an interior of the flexure shaft and terminating at an electronics assembly housed within the distal tip.

12. The endoscope of claim 1, wherein the control ring provides a cylindrical body that defines an interior, and wherein an end of the flexure shaft is received within the interior.

13. The endoscope of claim 1, wherein the distal tip provides one or more interlocking features configured to mate with one or more corresponding interlocking features provided by the control ring, and wherein the distal sealing extrusion covers an interface of mated engagement between the one or more interlocking features of the distal tip and the control ring.

14. The endoscope of claim 13, wherein the distal tip provides a proximal shoulder, and wherein the distal sealing extrusion extend to and contacts the proximal shoulder.

15. The endoscope of claim 1, wherein one or more wire channels are defined in the control ring and the one or more pull wires are received within the one or more wire channels, and wherein the distal sealing extrusion covers the one or more wires received within the one or more wire channels.

16. The endoscope of claim 1, wherein the distal sealing extrusion is made of a medical grade polymer and is heat shrinkable.

17. The endoscope of claim 1, wherein the distal sealing extrusion is made of a medical grade polymer and is a flowable plastic.

18. An endoscope, comprising:
an elongate shaft having opposing first and second ends and including:
a distal jacket extending proximally from the first end and defining a central lumen and one or more minor lumens;
a flexure shaft extending within the central lumen;
a proximal jacket extending distally from the second end;
a proximal hypotube extending within the proximal jacket; and
a mid-hub coupler interposing and operatively coupling the proximal hypotube to the flexure shaft;
a distal tip arranged at the first end of the shaft; and
one or more pull wires extending along the shaft between the first and second ends, the one or more pull wires extending within an interior of the proximal hypotube, and transitioning to an exterior of the flexure shaft at the mid-hub coupler,
wherein the one or more pull wires extend within the one or more minor lumens along a length of the distal jacket.

19. The endoscope of claim 18, further comprising:
a control ring that operatively couples the distal tip to the flexure shaft;
a distal sealing extrusion secured to the shaft and sealing an interface between the control ring and at least one of the distal tip and the flexure shaft; and
a mid-sealing extrusion provided at an interface between the proximal hypotube and the flexure shaft and configured to seal the interface between the proximal hypotube and the flexure shaft.

20. The endoscope of claim 18, wherein one or both of the distal and mid-sealing extrusions is made of a medical grade polymer and is heat shrinkable.
